(19) United States
(12) Patent Application Publication
(10) Pub. No.: US 2008/0043470 A1
(43) Pub. Date: Feb. 21, 2008

(54) Reflector lamp or illumination system

(76) Inventor: Randal Lee Wimberly, Lake Havasu City, AZ (US)

Correspondence Address: Randal L. Wimberly, 905 Tyree Road, Paducah, KY, 42003, US

(21) Appl. No.: 11/506,977

(22) Filed: Aug. 17, 2006

(51) Int. Cl. F21S 8/00

(52) U.S. Cl. 362/268

(57) ABSTRACT

A reflector lamp or illumination system comprising a concave reflector having a parabolic or ellipsoidal front section with the focal point being a ring of points that extends horizontally outwardly from the reflector system focal point by a distance of not less than one, and no more than three, times the width of the light source used, a spherical rear section with it's focal point substantially the same focal point as the reflector system, and a finite light source located at the focal point of said reflector system. The reflector sections are dimensioned so that light rays from the finite light source and those which are reflected by the spherical rear section are reflected and re-reflected by the front section with less divergent beam angles and distributed more evenly into the desired projected beam pattern with more of said rays being projected into the desired beam path. Additionally the light rays, re-reflected by the front section, consist of uncompressed light and energy components which provide a beam pattern which is substantially more even in light and energy distribution, does not have compressed light and energy producing hot spots of light and heat at the center of the projected beam pattern or gate, and is therefore less harmful to parts such as lighting fixture parts, plastic lens and items being projected such as plastic color media, film, and slides. Alternately the front reflector section surface has radial convex curved facets to produce a smoother beam field. Additionally the rear reflector section can consist of multiple spherical sections with slightly different focal points to produce a smoother beam field and project more of the light radiated from the light source.

### REFERENCES CITED

| | | |
|---|---|---|
| U.S. Pat. No. 6,586,864 | Jul. 1, 2003 | Zhou, et al. |
| U.S. Pat. No. 6,488,379 B2 | Dec. 3, 2002 | Kane |
| U.S. Pat. No. 6,168,293 B1 | Jan. 2, 2001 | Lieszkovszky et. al |
| U.S. Pat. No. 5,345,371 | Sept. 6, 1994 | Cunningham, et al. |
| U.S. Pat. No. 5,272,408 | Dec. 21, 1993 | Levin et. al |
| U.S. Pat. No. 4,755,918 | Jul. 5, 1988 | Pristash et. al |
| U.S. Pat. No. 4,654,758 | Mar. 31, 1987 | Szekacs et. al |
| U.S. Pat. No. 4,447,865 | May 8, 1984 | VanHorn et. al |
| U.S. Pat. No. 3,443,086 | May 6, 1969 | Rikis |
| U.S. Pat. No. 3,267,274 | Nov. 26, 1963 | Johnson |
| U.S. Pat. No. 1,995,012 | Mar. 19, 1935 | Rivier |
| U.S. Pat. No. 1,575,327 | Mar. 2, 1926 | Garford et. al |

### TECHNICAL FIELD

The present invention is in the field of reflector lamps and more particularly in the field of optical reflectors for use in collecting a high proportion of the emitted light and projecting a high-intensity beam.

### BACKGROUND OF THE INVENTION

Light reflectors have long been used to bounce light off of a reflective surface. Light generally shines in all directions from a light source. However, if light shining in all directions from a light source is not useful, a reflective surface can be employed to reflect light towards a direction in which the light is useful. In this way, light reflectors increase the efficiency of a lamp or light source.

One general type of reflector comprises a concave reflector having a parabolic contour with respect to a focal point, so as to reflect frontwardly and along the lamp axis light emitted by a light source located at and near the focal point. The cross section of the reflector, perpendicular to the lamp axis, usually is circular with the diameter thereof varying with the distance from the focal point.

Another general type of reflector comprises a concave reflector having an ellipsoidal contour with respect to a focal point, so as to reflect frontwardly and along the lamp axis light emitted by a light source located at and near one of the ellipsoidal focal points to the second ellipsoidal focal point located frontwardly and determined by the size of the geometric ellipsoidal contour. The light leaving the ellipsoidal reflector usually passes through a gate and then enters into a series of lenses to more accurately control dispersion of the projected beam of light. The cross section of the reflector, perpendicular to the lamp axis, usually is circular with the diameter thereof varying with the distance from the focal point.

Additionally, a cone of light rays, originating from the light source, pass, unreflected, through the front of the reflector; the angle of this cone of rays being determined and defined by the front rim of the reflector. The more widely divergent light rays of the cone of rays, that is, the rays passing relatively nearer to the rim of the reflector, have such a large sideways component of direction so as to fall outside of the desired light pattern or gate and therefore are wasted.

The wasted, divergent light can be reduced, and the optical efficiency improved, by making the reflector deeper, that is longer, so that relatively more of the light is reflected in the desired direction and the cone of non reflected light is narrowed. However, there are practical limitations on increasing the depth of the reflector, such as cost, weight and awkwardness of use. Also, with a given maximum diameter as the reflector is made deeper, the focal point moves closer to the rear surface, which complicates positioning of the light source in reflector systems and if the light source is a filament inside a reflector lamp there is accelerated blackening of the nearby rear area of the reflector due to evaporation of the filament material (usually tungsten). This accelerated blackening in the reflector lamp can be alleviated by providing a concave recess at the rear portion of the reflector but has the drawback of reducing optical efficiency. In a reflector or reflector system, as the focal point moves closer to the rear surface, the percentage of reflected energy from the finite light source is compressed and packed much more tightly toward the center of the reflector and, as a result, the opening for the finite light source will remove an area of the reflector that would normally reflect a larger percentage of the light being generated than if it were a shallow reflector, thus reducing optical efficiency of the deep reflector system.

Additionally, it has now been found that as the parabolic or ellipsoidal contour of the reflector is made deeper and the focal point is moved closer to the rear of the reflector, the reflected light and heat from the light source is packed more tightly and reflected in a compressed narrower band at the center of the projected beam pattern or gate. This increase in light and heat energy is increased logarithmically as the reflector depth is increased in relation to the same width. This causes uneven projected beam patterns with concentrated areas know as hot spots in a parabolic reflector system or hot spots and uneven coverage of light causing shadows in the gate of an ellipsoidal reflector system. These compressed areas also concentrate heat at the center of the projected beam that can be very detrimental to parts of the illumination system and accessories used with these systems such as, but not limited to, color gel material, gobos, plastic lens, projection slides, and film used in motion picture projectors.

Another problem encountered with deep reflectors is that light generated from the extreme ends of a light source strike the reflector at angles that are not advantageous and produce light rays that fall outside of the desired beam path. This problem is not as severe with reflectors that have a more shallow depth to width or diameter but then more light is lost from direct radiation that does not strike the reflector and is wasted.

Another problem encountered in reflector systems of this kind is that the imaged light beam can sometimes have an intensity that varies radially such that a concentric ring pattern is provided. These undesired patterns occurs because of the particular kind of filament used in the lamp. Each point on the reflector reflects light toward the gate so as to produce a magnified image of the filament, and the superposition of the images resulting from all points on the reflector sometimes can provide these undesired patterns.

These undesired patterns have been overcome by providing the reflector with a plurality of small, trapezoidal facets, typically flat sections, that function to blur the projected image. The facets have edges that are arranged both radially and circumferentially. Although such a reflector structure is generally effective in eliminating this effect, it is believed that this solution misdirects an excessive amount of light so as not to be incorporated into the projected beam.

It should therefore be appreciated that there is a need for an improved reflector or reflector lamp that can utilize more of the energy radiated from a light source to image a beam of light at a distant location, produce as smooth a beam field as possible, and yet that does not unduly transmit undesired infrared light and heat. The present invention fulfills this need.

### SUMMARY OF THE INVENTION

Objects of the invention are to provide a reflector, or reflector lamp, having an improved optical efficiency and a projected beam pattern or gate projection area including more energy and with substantially more even projection of said energy in the desired beam pattern or gate without areas of compressed energy known as hot spots while also lowering the concentration of heat at the center of the projected beam. This permits a lamp design or illumination system having lower power consumption in a more compact form and a system that can be higher in power but not as harmful to lens made of plastic, color media, media that is being projected, objects, or humans that are in the projected beam path.

These and other objects of the present invention are achieved by providing a lamp unit or a reflector system comprising a reflector and a finite light source wherein the reflector has a parabolic front section or ellipsoidal front section, and a spherical rear section. The front and rear reflector sections are joined together near the intersection of a plane passing through one of the foci of an ellipsoidal front reflector section or the focal point of a parabolic front reflector section and substantially the focal point of the spherical rear reflector section. The focal point of the front reflector section is not a single point as normally found in prior art reflector curves but is a continuous series of points along a ring that extends horizontally outwardly from the reflector system focal point by a distance of not less than one, and no more than three, times the width of the light source used. The focal point of the rear spherical reflector section is substantially the focal point of the reflector system. Additionally, the spherical rear section allows all of the light rays which are reflected by the spherical rear section from a finite light source positioned at the focal point of the front reflector section to be redistributed over the larger surface of the front parabolic or ellipsoidal front section and thus recovering light that would normally be wasted while also not compressing said light into the center of the beam pattern as do prior art reflector systems but re-reflecting said light into the beam pattern in substantially the same geometric configuration as said parabolic or ellipsoidal front sections but distributed more evenly from center to outer edge of said projected beam producing a smoother field.

Alternately, the amount of heat produced by the reflector lamp or reflector illumination system can be reduced even more if the reflector sections are made of, or coated with, a cold mirror material that allows the heat to pass through and reflects only the visible part of the light being generated by the finite light source. Additionally, the heat radiated from the front of the finite light source can be reduced by placing a hot mirror or hot mirror coated lens in the front of the opening of the reflector lamp or reflector illumination system to reflect the heat and allow the visible light to pass through.

Additionally, the quality of the projected beam of light can be enhanced by making the reflective surface of the front reflector section to have facets or fluted areas. An alternate construction allows for these facets to be radial with convex surfaces. These convex surfaces are calculated to produce different magnification ratios and project the image of the light source at different sizes thereby blurring the projected filament image, reducing shadows, and smoothing the desired projected beam field without loss of output.

Additionally, the quality of the projected beam of light can be enhanced by making the rear reflector section of multiple spherical sections each having a different focal point that is very close to or coincident with the reflector system focal point and each located along the longitudinal axis of the reflector system. The rear spherical section of said rear reflector section can have a focal point along the longitudinal axis of the reflector system at a point which causes the reflected light from that individual section to produce a beam of light that diverges at an angle of not less than 4 degrees and not more than 14 degrees. These reflections of the light source create multiple virtual filaments that appear to be emanating light from slightly different positions thereby blurring the projected filament image, reducing shadows, and smoothing the desired projected beam field, again without loss of output

Still further advantages of the present invention will become apparent to those of ordinary skill in the art upon reading and understanding the following detailed description of the preferred embodiments.

### BRIEF DESCRIPTION OF THE DRAWING

FIG. 1 is a dimensional view of a reflector system in accordance with the invention, including a light source and measurements showing the range and position of the continuous ring of focal points for the front reflector section and the substantial focal point for the rear reflector section.

FIG. 2 is a schematic diagram of an incandescent illumination system in accordance with a preferred embodiment of the invention including an incandescent lamp, a reflector with a parabolic front section joined with a spherical rear section, and an optional lens.

FIG. 3 is a schematic diagram of an alternative embodiment of an incandescent illumination system or fixture in accordance with the invention, this system including an incandescent lamp, a reflector with an ellipsoidal front section joined with a spherical rear section, a gate, and a collimating lens.

FIG. 4A is a schematic diagram showing a side view of an alternative embodiment of a reflector system in accordance with the invention, this system including a parabolic front section with radial facets joined with a rear section made of multiple spherical sections.

FIG. 4B is a schematic diagram showing a front view of an alternative embodiment of a reflector system in accordance with the invention, this system including a parabolic front section with radial facets joined with a rear section made of multiple spherical sections.

FIG. 5 is a computer generated ray tracing schematic diagram of a beam pattern produced by a prior art parabolic reflector system.

FIG. 6 is a computer generated ray tracing schematic diagram of a beam pattern produced by an alternative embodiment of a reflector system in accordance with the invention shown in FIG. 4A.

### DETAILED DESCRIPTION OF THE INVENTION

Reference will now be made in detail to the present preferred embodiment of the invention, examples of which are illustrated by the accompanying drawings. While the invention will be described in connection with a preferred embodiment, it will be understood that it is not intended to limit the invention to that embodiment.

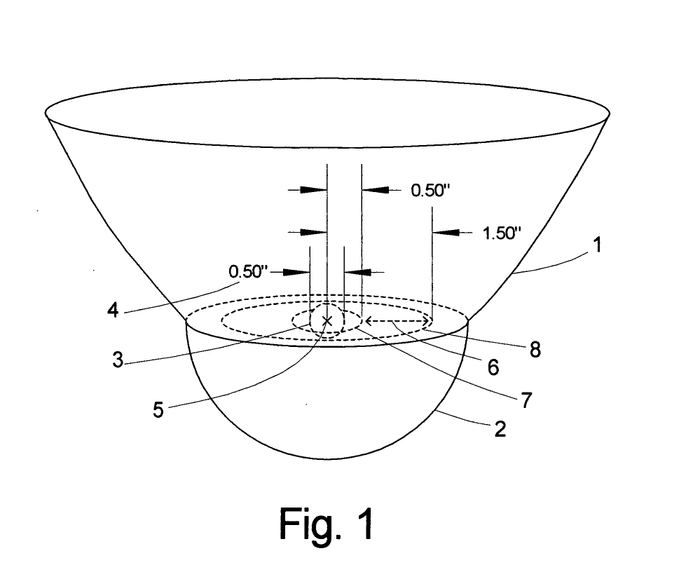

FIG. 1 is a dimensional diagram of a first embodiment of a reflector system in accordance with the invention. The internal hidden objects are displayed as dashed lines. The reflector has a parabolic front section 1 and a spherical rear section 2. The light source 3 is located at the focal point 5 of the reflector system and has a width of 0.50 inches 4. The focal point used to produce the exact curve for the front parabolic section 1 is a ring of continuous points that is located horizontally outwardly from the reflector system longitudinal axis in a range 6 with a radius of not less that one times the width of the light source, which in this case is 0.50 inches 7, and not more that three times the width of the light source, which in this case is 1.50 inches 8. The exact radius of the focal point ring for an individual reflector system is determined by the depth to width ratio of said reflector system and must be calculated using computer ray tracing programs to produce the desired projected beam pattern. The front and rear reflector sections are joined together near the intersection of a plane passing through the focal point ring of the front reflector section 1 and the focal point 5 of the spherical rear reflector section 2. This system captures more of the light radiating from the rear of the light source and the front reflector geometry reduces the angle of divergence of reflected rays that are produced by light from the extreme outer areas of a real world light source 3 that has a three dimensional volume and not a theoretical single point. This reduction in divergence creates a more efficient beam of energy with higher intensity and output.

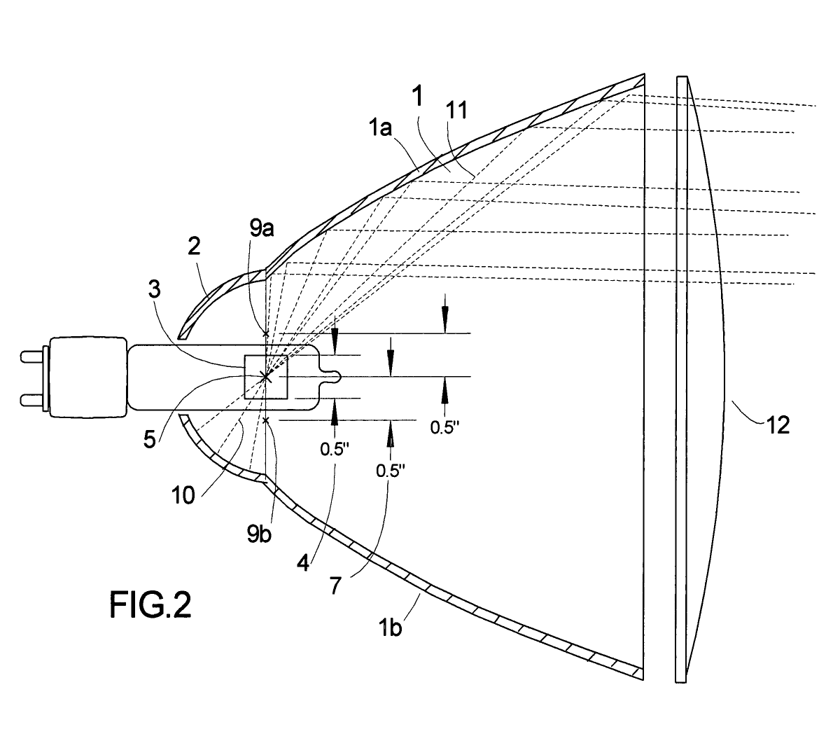

FIG. 2 is a schematic diagram of a first embodiment of an incandescent illumination system in accordance with the invention. The reflector system has a parabolic front section 1 and a spherical rear section 2. The front and rear reflector sections are joined together near the intersection of a plane passing through the upper focal point 9a and the lower focal point 9B of the focal ring of the parabolic front reflector section 1 and the focal point 5 of the spherical rear reflector section 2. The exact curve of the upper parabolic reflector section 1a is produced by using the point 9a as the focal point for the parabola. The exact curve of the lower parabolic reflector section 1b is produced by using the point 9b as the focal point for the parabola. These points 9a and 9b fall along a focal ring with a radius of 0.50 inches 7 which is equal to one times the width of the finite light source 3. The focal point 5 of the rear spherical reflector section 2 is substantially the focal point 5 of the reflector system. Additionally, all of the heat and light rays from a finite light source 3 positioned at the focal point 5 of the reflector system 10 which are reflected by the spherical rear section 2 are redistributed over the larger surface of the parabolic front section 1 and re-reflected into the beam pattern in substantially the same geometric configuration as the light rays 11 reflected by said parabolic front section 1 but distributed more evenly from center to outer edge of said projected beam producing a smoother field while also allowing more of the heat to be dissipated by the larger surface area of said parabolic front reflector section 1. This system captures more of the light radiating from the rear of the light source and the front section reflector geometry reduces the angle of divergence of reflected rays that are produced by light from the extreme outer areas of a real world light source 3 that has a three dimensional volume and not a theoretical single point. This reduction in divergence creates a more efficient beam of energy with higher intensity and increased output.

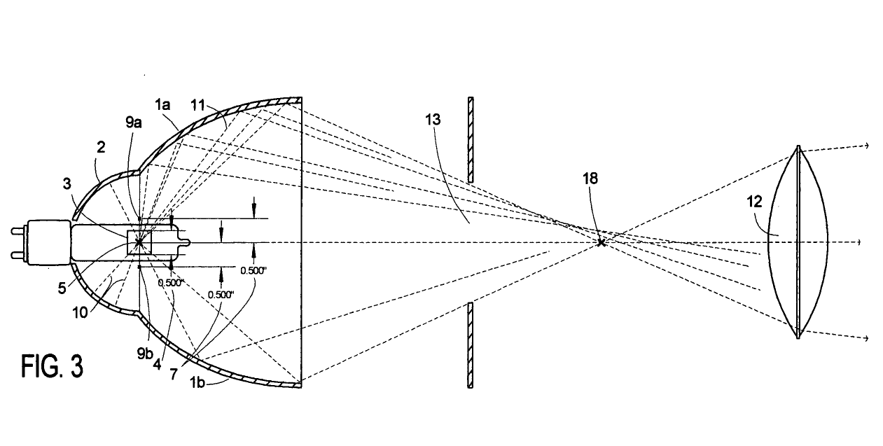

FIG. 3 is a schematic diagram of an alternate embodiment of an incandescent illumination system in accordance with the invention. The reflector system has an ellipsoidal front section 1 and a spherical rear section 2. The front and rear reflector sections are joined together near the intersection of a plane passing through the upper focal point 9a and the lower focal point 9B of the focal ring of the ellipsoidal front reflector section 1 and the focal point 5 of the spherical rear reflector section 2. The exact curve of the upper ellipsoidal reflector section 1a is produced by using the point 9a as the rear foci point for the ellipsoidal. The exact curve of the lower ellipsoidal reflector section 1b is produced by using the point 9b as the rear foci point for the ellipsoidal. These points 9a and 9b fall along a focal ring with a radius of 0.50 inches 7 which is equal to one times the width of the finite light source 3 and whose center is the reflector system focal point 5. The focal point of the rear spherical reflector section 2 is substantially the focal point 5 of the reflector system. Additionally, all of the heat and light rays 10 from a finite light source 3 positioned at the focal point 5 of the reflector system which are reflected by the spherical rear section 2 are redistributed over the larger surface of the ellipsoidal front section 1 and re-reflected into the beam pattern in substantially the same geometric configuration as the light rays 11 reflected by said ellipsoidal front section 1 but distributed more evenly from center to outer edge of said projected beam producing a smoother field while also allowing more of the heat to be dissipated by the larger surface area of said ellipsoidal front reflector section 1. This system captures more of the light radiating from the rear of the light source and the front section reflector geometry reduces the angle of divergence of reflected rays that are produced by light from the extreme outer areas of a real world finite light source 3 that has a three dimensional volume and not a theoretical single point. This reduction in divergence creates a more efficient beam of energy with higher intensity and increased output. This combined rays 10 and 11 then enters the gate 13 and passes the other foci 5b of the ellipsoidal front reflector section 1 and passes through the lens 12 producing a smoother and more accurate field.

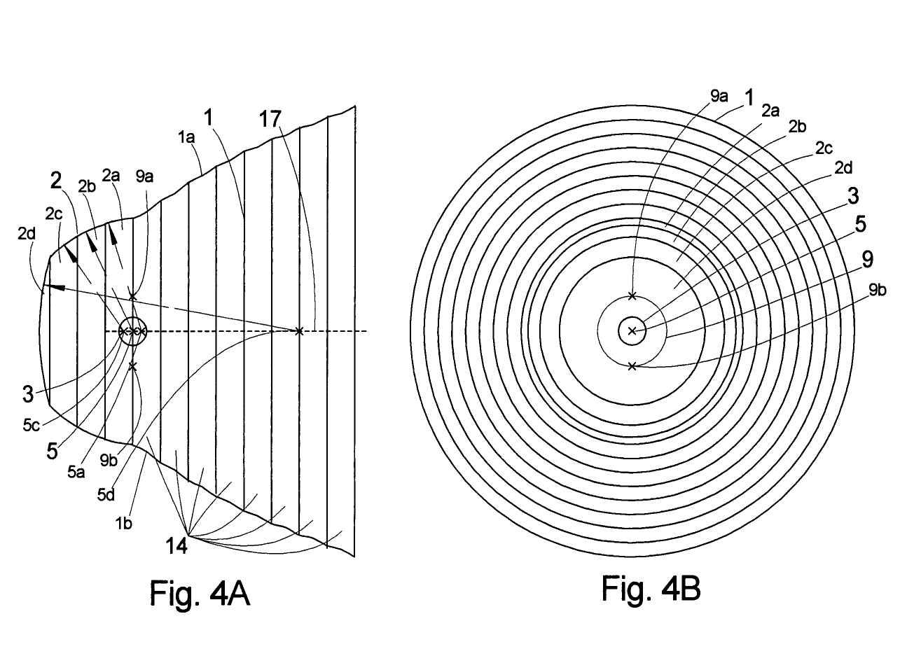

FIG. 4A and FIG. 4B are side and front views, respectively, of an alternate embodiment of a reflector system in accordance with the invention. The reflector system has a parabolic front section 1 and a spherical rear section 2. The light source 3 is located at the focal point 5 of the reflector system. The focal point used to produce the exact curve for the front parabolic section 1 is a ring of continuous points 9 that is located horizontally outwardly from the reflector system longitudinal axis 17 with a radius dimension of not less that one times the width of the light source used 3 and not more that three times the width of said light source 3. The exact radius of the focal point ring 9 for an individual reflector system is determined by the depth to width ratio of said reflector system and must be calculated using computer ray tracing programs to produce the desired projected beam pattern. The parabolic front section 1 has a surface made of convex radial rings or facets 14 with each convex surface produced by a different radius dimension. The surface of these radial facets 14 curve inward toward the longitudinal axis 17 of the reflector system and reflect images of the light source at different magnification ratios thereby blurring and smoothing the projected light field. The spherical rear section 2 of the reflector system is divided into multiple spherical sections 2a, 2b, 2c, and 2d, each of which has separate focal points 5a, 5, 5c, and 5d located along the longitudinal axis of the reflector system. The forward sections 2a,2b, and 2c of the multiple spherical section have focal points that are just ahead of 5a, just behind 5c, or coincident with 5 the focal point of the entire reflector system. The last section 2d of the multiple spherical section has a focal point 5d located along the longitudinal axis 17 of the reflector system but further away from the focal point 5 of the reflector system with this focal point 5d calculated to produce a projected image or beam pattern with a total divergence angle of not less than 4 degrees and no more than 14 degrees. These multiple spherical reflector sections reflect a larger portion of the radiated light from the light source 3 making the reflector system more efficient and said light source appear to be radiating from four slightly different points thereby additionally blurring and smoothing the projected light field but without loss of output. The front and rear reflector sections are joined together near the intersection of a plane passing through the focal point ring 9 of the front reflector section 1 and the focal point 5 of the spherical rear reflector section 2. The front reflector geometry reduces the angle of divergence of reflected rays that are produced by light from the extreme outer areas of a real world light source 3 that has a three dimensional volume and not a theoretical single point. This reduction in divergence creates a more efficient beam of energy with higher intensity and output.

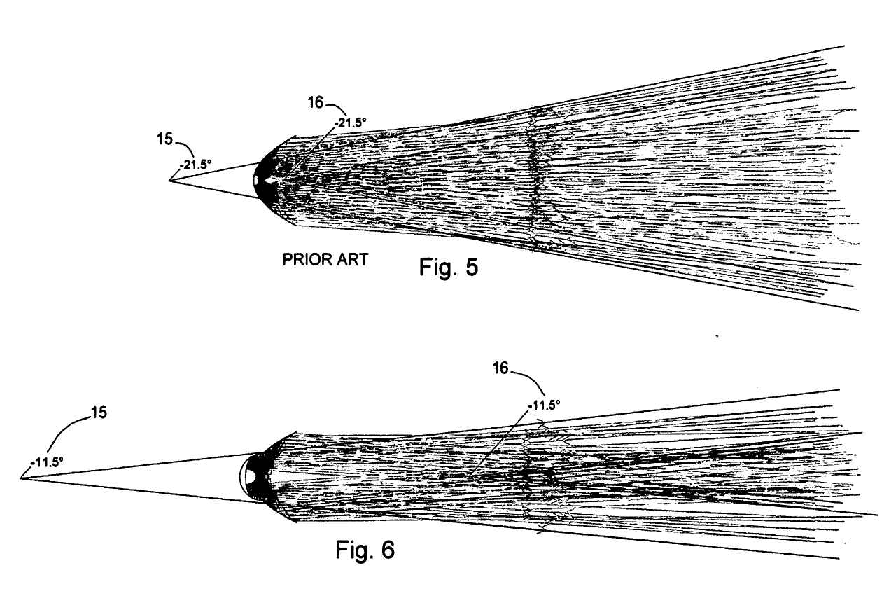

FIG. 5 is a computer generated ray tracing schematic diagram of an 8 inch diameter reflector with a standard Prior Art parabolic contour showing the beam pattern produced by said reflector with a light source generating 36 rays of light from the extreme rear of the light source, 36 rays of light from the center of said light source, and 36 rays of light from the extreme front of said light source. The light source has been placed near the focal point of the system to produce a reflected beam of light with the lowest amount of total system divergence in order to create the smoothest possible projected beam field with the highest possible output. It can be seen that the most divergent rays are those generated from the extreme outer areas of the light source such as the extreme forward point and the extreme rearward point. The angle of divergence of the reflected beam produced by the extreme forward point of radiation is shown to be 21.5 degrees 16. The angle of divergence of the reflected beam produced by the extreme rearward point of radiation is shown to be 21.5 degrees 15.

FIG. 6 is a computer generated ray tracing schematic diagram of an 8 inch diameter reflector with a reflector system contour in accordance with the present invention showing the reflected beam pattern produced by a light source generating 36 rays of light from the extreme rear of the light source, 36 rays of light from the center of said light source, and 36 rays of light from the extreme front of said light source. The light source has been placed near the focal point of the system to produce a reflected beam of light with the lowest amount of total system divergence in order to create the smoothest possible projected beam field with the highest possible output. It can be seen that the most divergent rays are those generated from the extreme outer areas of the light source such as the extreme forward point and the extreme rearward point. The angle of divergence of the reflected beam produced by the extreme forward point of radiation is shown to be 11.5 degrees 16. The angle of divergence of the reflected beam produced by the extreme rearward point of radiation is shown to be 11.5 degrees 15. This shows the reduction in beam divergence is approximately 46.5% in relation to the standard Prior Art system of FIG. 5 and proves that the increase in system output will be substantial.

Although not shown in the drawings, a first embodiment of an incandescent lamp in accordance with the invention is disclosed. The lamp includes a light source selected from the group consisting of halogen, discharge, and semiconductor light sources and an envelope comprised of a reflector with a spherical rear section and a parabolic front section with clear front lens attached. The light source is located at the focal point of the reflector system. The focal point used to produce the exact curve for the front parabolic section is a ring of continuous points that is located horizontally outwardly from the reflector system longitudinal axis with a radius of not less that one times the width of the light source and not more that three times the width of the said light source. The exact radius of the focal point ring for an individual reflector system is determined by the depth to width ratio of said reflector system and must be calculated using computer ray tracing programs to produce the desired projected beam pattern. The front and rear reflector sections are joined together near the intersection of a plane passing through the focal point ring of the front reflector section and the focal point of the spherical rear reflector section. This system captures more of the light radiating from the rear of the light source and the front reflector geometry reduces the angle of divergence of reflected rays that are produced by light from the extreme outer areas of a real world light source that has a three dimensional volume and not a theoretical single point. This reduction in divergence creates a more efficient beam of energy with higher intensity and output.

What is claimed is:

1. An illumination system for projecting a beam of light, comprising:
a concave reflector system configured to be substantially symmetrical about a longitudinal axis wherein the reflector has a parabolic front section with the focal point being points along a ring that extends horizontally outwardly from the reflector system focal point by a distance of not less than one, and no more than three, times the width of the light source used, and a spherical rear section joined together near the intersection of a plane passing through the focal point ring of the parabolic front reflector section and substantially the focal point of the spherical rear reflector section:
an incandescent lamp with the approximate center of the light source placed substantially at the focal point of the reflector system: and
a lens located at or near an open end of the front reflector section:
wherein a substantial portion of the light emitted by the lamp impinges on, and is redirected by, the reflector system to project a beam of light substantially parallel with the longitudinal axis of the reflector system.

2. The illumination system of claim 1, wherein the reflector surfaces are coated with a material or made in a way that allows the infrared and heat energy of the light source to pass through but reflects the visible spectrum of the light source.

3. The illumination system of claim 1, wherein the front lens is coated with a material or made in a way that allows the infrared and heat energy of the light source to be reflected but allows the visible spectrum of the light source to pass through.

4. The illumination system of claim 1, wherein the light source is selected from the group consisting of halogen, discharge, and semiconductor light sources.

5. The illumination system of claim 1, wherein the lens is made of plastic.

6. The illumination system of claim 1, wherein the rear section of the reflector system consist of multiple spherical sections each having a different focal point with said focal points being just behind, just ahead, or substantially the same as the focal point of the reflector system and with the last spherical section having a focal point that allows for the projection of a beam section with an angle of projection of not less than 4 degrees and no more than 14 degrees.

7. The illumination system of claim 1, wherein the front parabolic section of the reflector system has a surface that consist of facet shapes selected from the group of radial rings with convex surfaces calculated to each have a different radius, radial rings of concave facets, radial rings of flat facets, longitudinal convex facets, longitudinal concave facets, longitudinal flat facets, trapezoidal convex facets, trapezoidal concave facets, and trapezoidal flat facets.

8. An illumination system for projecting a beam of light, comprising:
a concave reflector system configured to be substantially symmetrical about a longitudinal axis wherein the reflector has an ellipsoidal front section with the focal point being points along a ring that extends horizontally outwardly from the reflector system focal point by a distance of not less than one, and no more than three, times the width of the light source used, and a spherical rear section joined together near the intersection of a plane passing through one of the focal rings of the ellipsoidal front reflector section and substantially the focal point of the spherical rear reflector section:
an incandescent lamp with the approximate center of the light source placed at substantially the focal point as the spherical rear reflector section:
a gate having an aperture aligned with the longitudinal axis of the concave reflector; and
a lens aligned with the longitudinal axis of the concave reflector system and positioned on the side of the gate opposite the reflector and the incandescent lamp;
wherein a substantial portion of light emitted by the incandescent lamp is directed generally perpendicular to the longitudinal axis of the concave reflector to impinge on the reflector, which redirects the light through the gate to the lens, to project the beam of light.

9. The illumination system of claim 8, wherein the reflector surfaces are coated with a material or made in a way that allows the infrared and heat energy of the light source to pass through but reflects the visible spectrum of the light source.

10. The illumination system of claim 8, wherein the front lens is coated with a material or made in a way that allows the infrared and heat energy of the light source to be reflected but allows the visible spectrum of the light source to pass through.

11. The illumination system of claim 8, wherein the light source is selected from the group consisting of halogen, discharge, and semiconductor light sources.

12. The illumination system of claim 8, wherein the lens is made of plastic.

13. The illumination system of claim 8, wherein the rear section of the reflector system consist of multiple spherical sections each having a different focal point with said focal points being just behind, ahead, or substantially the same as the focal point of the reflector system and with the last spherical section having a focal point that allows for the projection of a beam section with an angle of projection of not less than 4 degrees and no more than 14 degrees: and
the front ellipsoidal section of the reflector system has a surface that consist of facet shapes selected from the group of radial rings with convex facets calculated to each have a different radius, radial rings of concave facets, radial rings of flat facets, longitudinal convex facets, longitudinal concave facets, longitudinal flat facets, trapezoidal convex facets, trapezoidal concave facets, and trapezoidal flat facets.

14. A lamp comprising:
an envelope with a concave reflector system configured to be substantially symmetrical about a longitudinal axis wherein the reflector has a parabolic front section with the focal point being points along a ring that extends horizontally outwardly from the reflector system focal point by a distance of not less than one, and no more than three, times the width of the light source used, and a spherical rear section joined together near the intersection of a plane passing through the focal point of the parabolic front reflector section and substantially the same focal point as the spherical rear reflector sections:
an incandescent light source with the approximate center placed substantially at the focal point of the reflector system: and
a lens located at the large end of the front reflector section:
wherein a substantial portion of the light emitted by the light source impinges on, and is redirected by, the reflectors to project a beam of light substantially parallel with the longitudinal axis of the lamp.

15. The lamp of claim 14, wherein the reflector surfaces of the lamp envelope are coated with a material or made in a way that allows the infrared and heat energy of the light source to pass through but reflects the visible spectrum of the light source.

16. The lamp of claim 14, wherein the front lens of the envelope is coated with a material or made in a way that allows the infrared and heat energy of the light source to be reflected but allows the visible spectrum of the light source to pass through.

17. The lamp of claim 14, wherein the light source is selected from the group consisting of halogen, discharge, and semiconductor light sources.

18. The lamp of claim 14, wherein the rear section of the reflector system is made of multiple spherical sections each having a different focal point with said focal points being just behind, just ahead, or substantially the same as the focal point of the reflector system, and with the last spherical section of the rear section of the reflector system having a focal point that produces a beam of light with an angle of projection of not less than 4 degrees and no more than 14 degrees.

19. The lamp of claim 14, wherein the front parabolic section of the reflector system has a surface that consist of facet shapes selected from the group of radial rings with convex facets calculated to each have a different radius, radial rings of concave facets, radial rings of flat facets, longitudinal convex facets, longitudinal concave facets, longitudinal flat facets, trapezoidal convex facets, trapezoidal concave facets, and trapezoidal flat facets.

20. The lamp of claim 14, wherein the front section of the reflector system has an ellipsoidal curvature.
